(19) United States
(12) Patent Application Publication
(10) Pub. No.: US 2014/0148966 A1
(43) Pub. Date: May 29, 2014

(54) Decentralized Volt/VAR Control for Advanced Distribution Automation Systems

(71) Applicants: Magdy Salama, Waterloo (CA); Ramadan El-Shatshat, Waterloo (CA); Mohamed El-Khatib, Waterloo (CA); Mohamed Ahmed, Waterloo (CA)

(72) Inventors: Magdy Salama, Waterloo (CA); Ramadan El-Shatshat, Waterloo (CA); Mohamed El-Khatib, Waterloo (CA); Mohamed Ahmed, Waterloo (CA)

(21) Appl. No.: 13/688,860

(22) Filed: Nov. 29, 2012

(51) Int. Cl. G05B 13/02

(52) U.S. Cl. CPC G05B 13/02
USPC 700/298

(57) ABSTRACT

A general decentralized voltage control scheme is proposed to coordinate the operation of DG, Voltage regulator and Capacitor banks. The present invention is based on placing a Remote Terminal Unit (RTUs) at each distribution generation (DG) and each at line capacitor. These RTUs being coordinated together through communication protocols form a multi-agent system. Novel decentralized system is proposed to estimate the voltage profile change as a result of injecting reactive power at the capacitor bus. Simulation results are presented to show the validity and the effectiveness of the present invention.

### FIELD OF THE INVENTION

The present invention relates to decentralized control systems for power distribution systems that provide coordination between distribution system and control equipment, such as voltage regulators, shunt capacitors, distributed generators and others.

### BACKGROUND AND SUMMARY OF THE INVENTION

Power distribution systems have become the lifeline of our world and even minute disturbance in them results in grave consequences. In order to provide a reliable power supply, while keeping up with the rapid increase in demand, new methods of power distribution and control systems are continuously being developed. One of the more recent changes, which is aimed at providing more power while addressing environmental policies regarding CO₂ emissions, is installation of more distributed generation (DG). Although there are many benefits gained by installing more DG, they also pose new challenges for the operation of the distribution system.

Volt/VAR control plays an import function in the current distribution systems. Efficient Volt/VAR control reduces system losses, improves voltage profile and hence enhances the delivered power quality and overall system reliability. Recent increases in the utilization of distribution generation (DG) in distribution systems have made it even more important to have a more efficient voltage control operation schemes. The presence of DG in distribution feeders significantly changes their voltage profiles and hence interrupts the load drop compensation function of voltage regulators and the voltage sensing capabilities of capacitor banks, which depend on ever-decreasing feeder's voltage profile. In addition, efficient coordination between feeder's capacitors and DGs would allow for the integration of more number of DGs in the system.

Most VAR control developments have been related to the planning of the reactive power. The optimal capacitor sizing and allocation problem has also been considered. However, the operation of the reactive power control equipment has received little attention. It has been the usual practice in utilities to operate capacitor banks based on local signals, such as time of day or current magnitude, with the aim to have the capacitors connected at maximum load and disconnected at minimum load.

The prior art discloses several methods to achieve an optimal reactive power control in the presence of DG. One method is to have a central point which monitors the status of the reactive power control equipment, performs a load forecast for a certain horizon, solves a reactive power optimization problem based on the forecasted conditions and finally determines the optimal settings for the reactive power control equipment. There are several problems associated with this approach: First, for large systems, the centralized approach will be too cumbersome. And, second, given that this approach is based on load forecasting, there is no guarantee for the accuracy of the solution, especially in the presence of renewable-based DG with varying output power.

Another emerging method is solving the problem in a decentralized manner. A Multi-Agent decentralized reactive power DG dispatch for the support of the system voltage has been suggested. The problem with this approach is that it assumes the existence of a moderator point which takes bids from DGs and calculates the optimal overall solution which is, more or less, a centralized way of solving the problem. Furthermore, a decentralized approach for the control of DG reactive power output was proposed to mitigate the voltage rise due to the connection of the DG. This work is not applicable for the control of other reactive power control equipment of the system such as Capacitors.

Currently, there is a need to adopt a more efficient Volt/VAR control schemes in order to achieve a more efficient and reliable distribution system for Smart Grids.

### SUMMARY

The present invention provides a device for decentralized optimal Volt/VAR control. It controls station's voltage regulators, and other line voltage regulators. It controls the switched capacitor banks, and other reactive power control devices, in real-time. It minimizes the system losses while maintaining acceptable voltage profile for the feeder. The system comprises of a series RTUs located at each DG, each voltage regulator and at each shunt capacitor of the feeder to form a Multi-Agent system and an algorithm that receive real time data from these devices and coordinates the operation of DGs. The algorithm estimates the change in the voltage profile due to the injection of reactive power at the capacitor bus to coordinate DGs. This newly invented decentralized Volt/VAR control system efficiently controls the voltage regulators and the switched capacitors of the distribution feeder in order to minimize system losses while maintaining feeder's voltage profile.

The first object of the present invention is to provide an effective method of coordinating DGs in a power distribution system.

The second object of the present invention is to optimally manage the reactive power resources of a power distribution system.

The third object of the present invention is to optimally control switched capacitors of a power distribution system.

The fourth object of the present invention is to maintain acceptable voltage profile in power distribution systems.

The fifth object of the present invention is to minimize system losses during the operation of DGs.

The sixth object of the present invention is to integrate more DGs in the distribution system.

The seventh object of the present invention is to provide an automated optimally operated power distribution system.

And finally, the eight object of the present invention is to have an effective coordination between DGs and capacitors in the power distribution systems.

To achieve the above mentions objectives, a novel coordinated voltage control technique is invented which provides efficient voltage regulation for multiple feeders in the presence of DGs. The technique is based on placing RTUs at each DG. Each RTU communicate with its neighbors. The maximum and minimum voltages of the feeder can be estimated based on the measurements of the RTU, and without having to measure the voltage at each and every bus of the system. Moreover, based on the analytical analysis, it is clear that locating RTU at each DG of the feeder represents the minimum number of RTU needed to estimate the voltage of the feeder accurately. Simulation results show the efficiency of the proposed technique in regulating the voltage of multiple feeders in real-time when DGs and loads change their values. Moreover, the proposed technique allows an increased DG penetration without violating the voltage profile of the system.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a schematic diagram illustrating a decentralized reactive power control system;

FIG. 2 shows a schematic diagram illustrating a distribution feeder;

FIG. 3 shows a schematic diagram illustrating a part of a distribution system;

FIG. 4 shows a schematic diagram illustrating a part of a distribution system;

FIG. 5 shows proposed system structure with communication link;

FIG. 6 shows details of RTU measurements;

FIG. 7 shows a graph representing the communication structure between the RTUs;

FIG. 8 shows a flow chart of the RTU algorithm;

FIG. 9 shows a flow chart of placing RTU at distribution feeder and their algorithm;

FIG. 10 shows a flow chart for distribution feeder in general cases;

FIG. 11 shows a distribution system that used for simulations; and

FIG. 12 shows a distribution system that used for simulations.

### DETAILED DESCRIPTION OF PREFERRED EMBODIMENTS

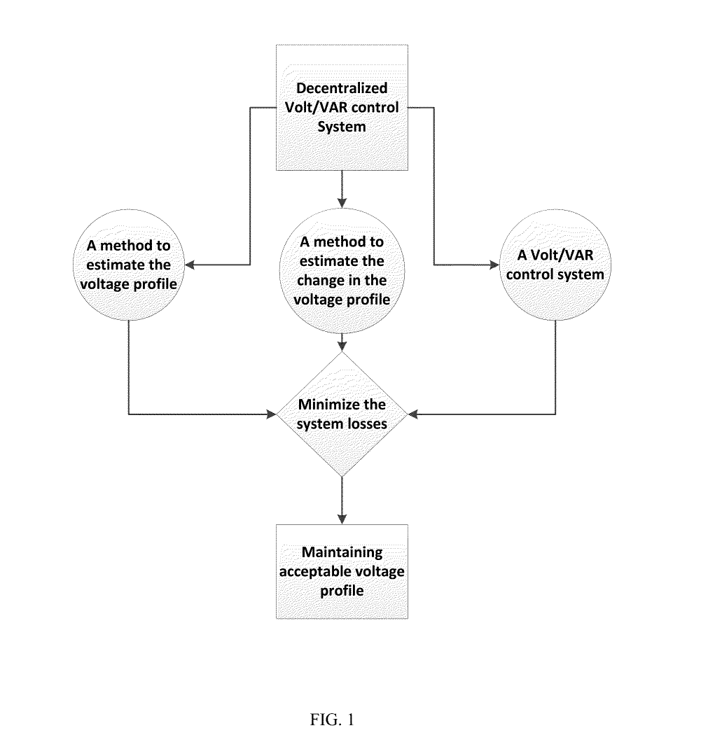

As shown in FIG. 1, the present invention has three major elements. One being a method to estimate the voltage profile based on the readings of the RTUs located at the DG buses and the capacitors buses. Another being a method to estimate the change in the voltage profile due to an injection of a reactive power at a capacitor bus. And the third being a Volt/VAR control system.

### I. Voltage Profile Estimation

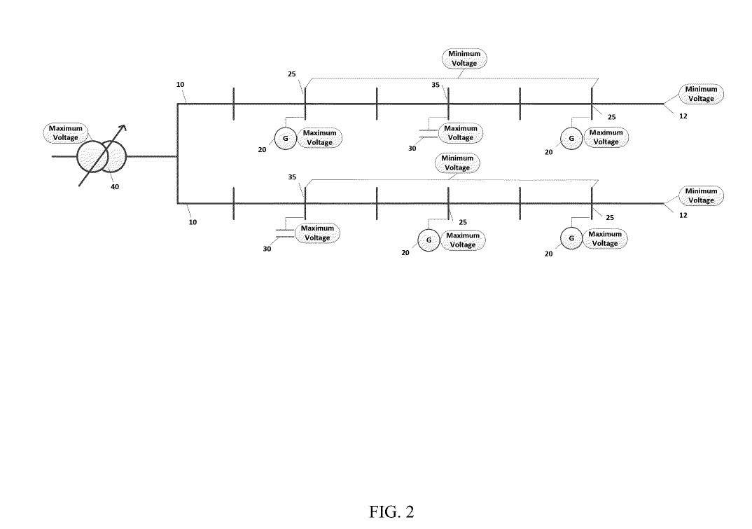

Knowledge of the maximum and the minimum voltages is used to obtain a voltage regulation and reactive power control for the feeder. FIG. 2 shows that for the voltage profile of a feeder 10, maximum voltage can happen only at the DG connecting buses 25, capacitors connecting buses 35, and the substation bus 40, provided that the R/X ratio of the feeder is constant along the whole feeder.

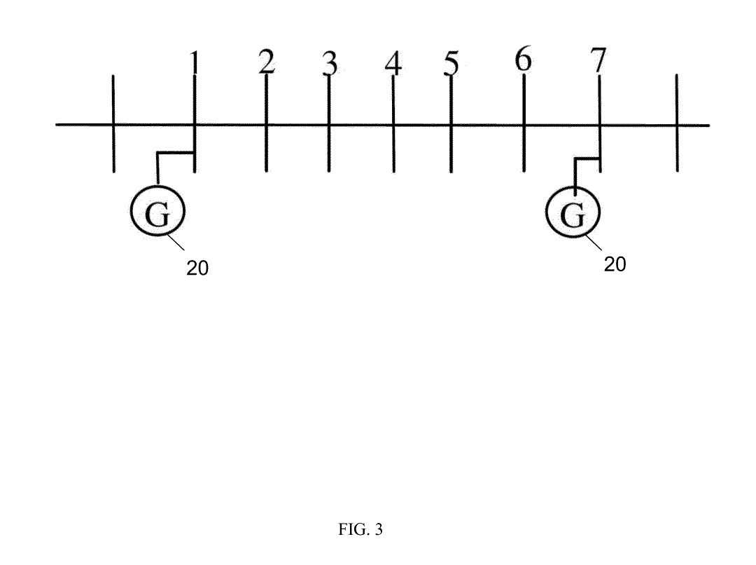

The minimum voltage points can occur only at the end of the feeder 12, as well as, in between any DG connecting buses 25 or between a DG bus and a capacitor bus or between two capacitors connecting buses. The voltage of the end points is read using RTUs or, alternatively, it is estimated in the same manner as described for the determination of the minimum points in between the DG 20, units. For the minimum points in between the DGs or capacitor 30, connecting buses, the following method gives the necessary and sufficient condition for the existence of these points. We have proved that there exists a minimum voltage point in between two DG connecting buses if and only if, for both DGs, the voltage of the DG neighboring bus, in the direction of the other DG, is less than the voltage of the DG bus. For instance, in FIG. 3, and based on this result, there is a minimum voltage point at one of the buses 2, 3, 4, 5 or 6, if and only if, the voltage of bus 1 is greater than the voltage of bus 2 and that the voltage of bus 7 is greater than the voltage of bus 6. Similarly, the same result will apply to the points in between the two capacitors as well as in between one capacitor 30, and one DG 20.

Note that, it is not important, from the point of view of voltage regulation, to know the exact location of the minimum voltage point. The importance of the above results is that it provides a guaranteed method to check for the existence of a minimum voltage point. In fact, knowing the mere existence of minimum voltage points is not enough, and the value of the minimum voltage point is needed.

A new method to coordinate the information is invented. This method is based on estimating the value of the minimum voltage point using the readings available at the DG or the capacitor bus only. This can be tailor-designed for each network based on the available information on its loading characteristics. An estimation, which gives the worst case value for the minimum voltage point can be used as a good lower bound for the minimum voltage point.

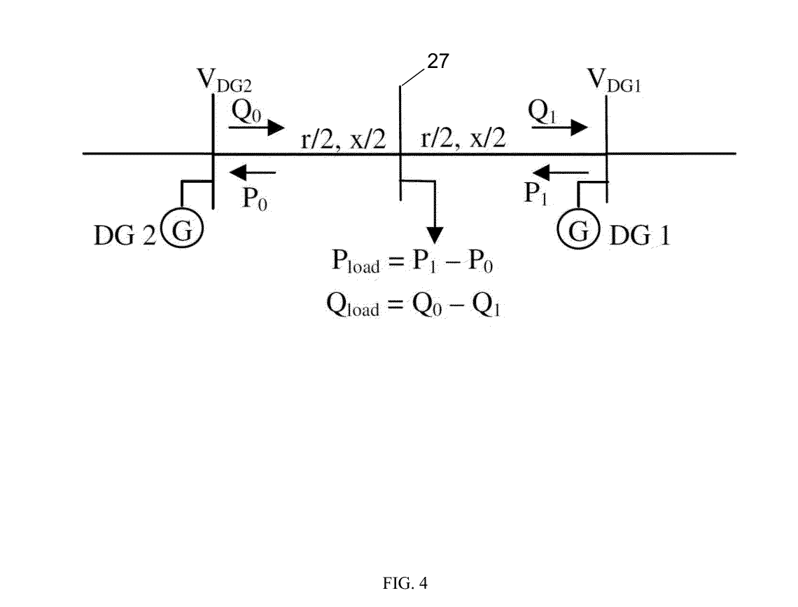

In the present system, it is assumed that the load between the two elements (DG or capacitor) is concentrated halfway between them 27. For FIG. 4, based on this assumption, the value of the minimum voltage point between the DG1 and DG2, if exists, as calculated by DG1 can be given as,

$${V}_{min , DG 1} = {V}_{DG 1} - ( {P}_{1} \frac{r}{2} - {Q}_{1} \frac{x}{2} ) \qquad [ Equation 1 ]$$

Also, the value of the assumed minimum voltage point calculated by DG2 is given by,

$${V}_{min , DG 2} = {V}_{DG 2} - ( - {P}_{0} \frac{r}{2} + {Q}_{0} \frac{x}{2} ) \qquad [ Equation 2 ]$$

Then we can take the average of these two values to get a better estimation, so,

$${V}_{min} = \frac{{V}_{min , DG 1} + {V}_{min , DG 2}}{2} \qquad [ Equation 3 ]$$

Finally substitute Equation (1) and (2) in Equation (3) we get,

$${V}_{min} = \frac{{V}_{DG 1} + {V}_{DG 2}}{2} - \frac{r}{4} ( {P}_{1} - {P}_{0} ) - \frac{x}{2} ( {Q}_{0} - {Q}_{1} ) \qquad [ Equation 4 ]$$

Equation (4) gives an estimation for the value of the minimum voltage point, if exist, between two elements using the data measured at elements' buses only.

Different loading schemes could have been assumed between the two elements, e.g., uniformly distributed. The choice of the assumed loading scheme should be network-specific.

### II. Estimation of Voltage Profile Change Due to the Injection of Reactive Power

The present invention is a decentralized Volt/VAR control system, which utilizes a decentralized way to estimate the change in the voltage profile due to the injection of reactive power at the capacitor connecting bus. Due to the connection of the capacitor to the feeder, the reactive power flow from station bus will be reduced by the amount of the reactive power injected at the capacitor bus, assuming the losses are negligible. Also, all reactive power flows between any two buses upstream of the capacitor bus will be reduced by the amount of the reactive power injected at the capacitor bus. On the other hand, the reactive power flow downstream of the capacitor will not be affected. Hence, the injected Q_{C} can be looked at, in a superposition fashion, as if it is flowing towards the supply.

Based on this concept we can analyze the voltage profile of any feeder as follows; The voltage difference between any two buses n and n−1, upstream of the capacitor bus with the capacitor out of service, can be written as:

V_{(n-1)old}−V_{(n)old}−P_{n-1,n}R_{n-1,n}+Q_{(n-1,n)old}X_{n-1,n} [Equation 5]

where V_{(n)old} represents the voltage of bus n prior to the connection of the capacitor. P_{n,n+1} represents the active power flow from RTUₙ bus to RTUₙ₊₁ bus. If active power flows from downstream to upstream, it is considered positive. Q_{(n,n+1)} represents the reactive power flow from RTUₙ bus to RTUₙ₊₁ bus. If reactive power flows from downstream to upstream, it is considered positive. X_{n-1,n} represents the reactance of the line segments between bus n−1 and bus n. R_{n-1,n} represents the resistance of the line segments between bus n−1 and bus n. Q_{(n-1,n)old} represents the reactive power flow from bus n−1 to bus n prior to the connection of the capacitor. After connecting the capacitor, Equation (5) can be written as:

V_{(n-1)new}−V_{(n)new}−P_{n-1,n}R_{n-1,n}+(Q_{(n-1,n)old}−Q_{C})X_{n-1,n} [Equation 6]

Subtracting (5) from (6) and rearranging, we get,

V_{(n)new}−V_{(n)old}=V_{(n-1)new}−V_{(n-1)old}+Q_{C}X_{n,n-1} [Equation 7]

Similarly,

V_{(n-1)new}−V_{(n-1)old}=V_{(n-2)new}−V_{(n-2)old}+Q_{C}X_{n-1,n-2} [Equation 8]

Ultimately,

V_{(1)new}−V_{(1)old}=V_{(0)new}−V_{(0)old}+Q_{C}X_{0,1} [Equation 9]

However bus 0 is the station bus, which we will assume to be stiff, then;

V_{(1)new}−V_{(1)old}−Q_{C}X_{0,1} [Equation 10]

Applying Equation (10) recursively in Equation (7) we can write:

V_{(2)new}−V_{(2)old}=Q_{C}X_{0,1}+Q_{C}X_{1,2} [Equation 11]

Generalizing (11), we get;

V_{(n)new}−V_{(n)old}=Q_{C}X_{0,1}+Q_{C}X_{1,2}+Q_{C}X_{2,3}++ . . . +Q_{C}X_{n-2,n-1}+Q_{C}X_{n-1,n} [Equation 12]

Put in compact form,

V_{(n)new}−V_{(n)old}+Q_{C}Σk₌₁^{k=n}X_{k-1,k} [Equation 13]

wherein V_{(n)new} represents the voltage of bus n after connecting the capacitor and V_{(n)old} represents the voltage of bus n prior to the connection of the capacitor. Equation (13) gives the change in the voltage of any bus upstream of the capacitor in terms of the amount of reactive power injected at the capacitor bus and feeder reactance.

On the other hand, the voltage change at any bus downstream of the capacitor bus is the same as the voltage change at the capacitor bus itself. This result follows directly from the fact that the reactive power flow downstream of the capacitor will not be changed due to the connection of the capacitor. In the light of Equation (13), a decentralized reactive power control scheme is developed, to calculate the new voltage at any bus due to the injection of reactive power at the capacitor bus.

### III. The System Structure

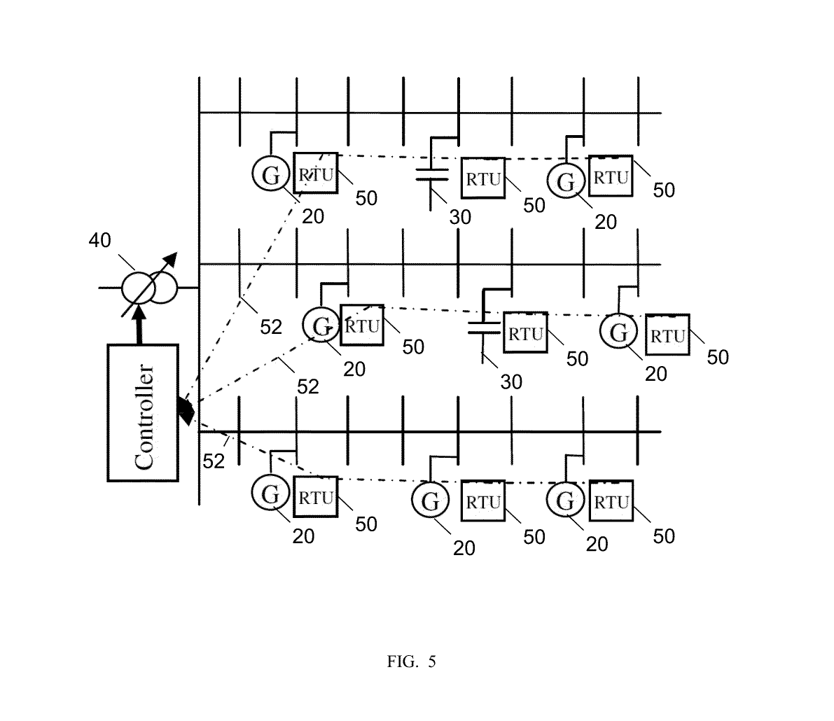

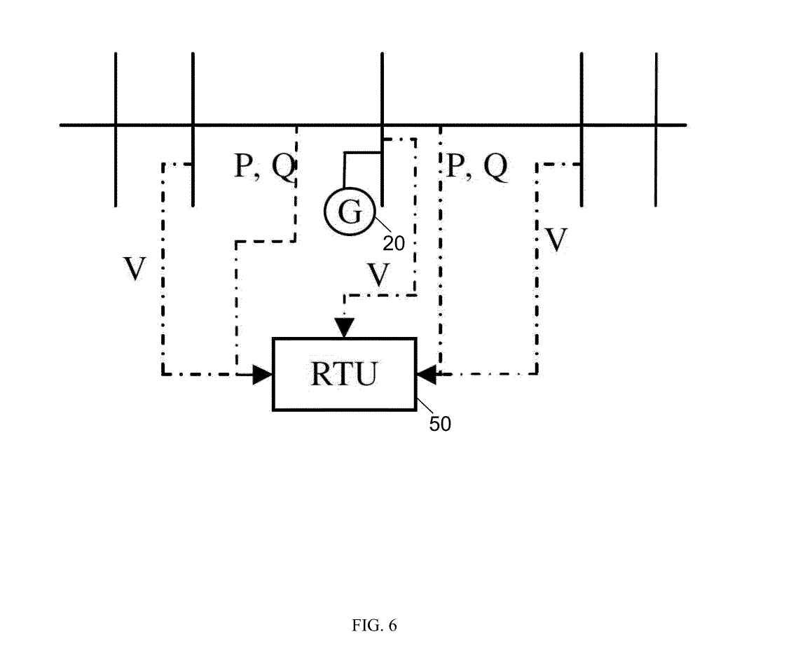

A system as show in FIG. 5 is disclosed, which consists of an RTU 50, at each DG 20, and each capacitor 30, and a communication link 52, between each two RTU 50, that have a power line connection between their elements (DGs or capacitors). Each RTU 50, is responsible for taking local measurements at its element, perform calculations, execute some logical statements and communicate with its neighbor RTU 50, or the station 40. FIG. 6 shows a detailed view for parameters measured by each RTU 50. Each RTU 50, measures the voltage of its element bus, active and reactive power flow in lines connected to its element bus and the voltages of the immediate neighbor buses of its element bus. Note that, the voltage of the immediate neighbor buses is needed only in order for the RTU 50, to get the trend of the voltage profile, increasing or decreasing, thus, measuring a point on the feeder adjacent to the RTU 50, could be sufficient. Based on the measurements of each RTU 50, it will be able to,
1. Measure a maximum voltage point of the voltage profile; the DG 20, or the capacitor 30, bus voltage.
2. Check one part of the condition for the possibility of the existence of a minimum voltage point of the voltage profile between its element and any neighbor element.
3. Estimate the value of the minimum voltage point on each side of its element, if exists.

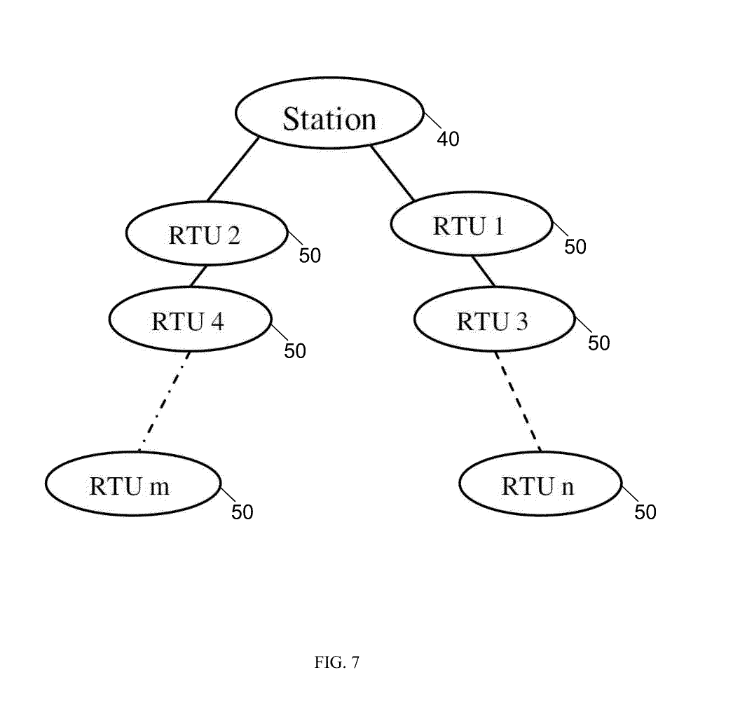

The communication structure between the RTU 50, can be represented by the graph of FIG. 7. This communication structure represents a tree in which the station 40, is the root of the tree, each feeder segment is a branch and each RTU 50, is a node.

### IV. Voltage Regulator Controller

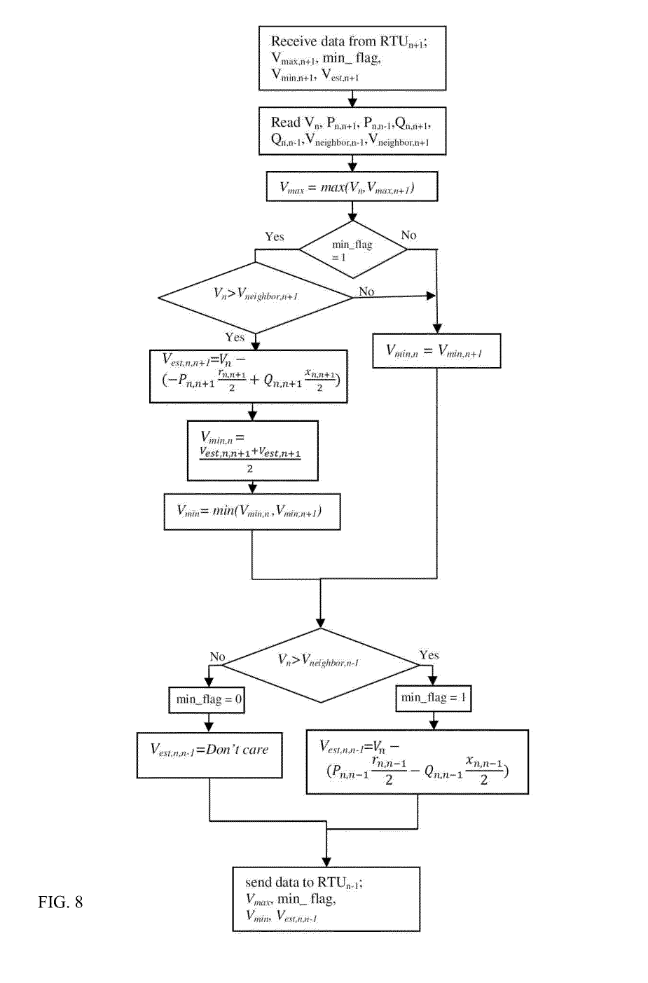

The goal of the algorithm executed by the RTU is to send to the voltage regulator the maximum and minimum voltages of each feeder. Let RTUₙ be the RTU connected to a certain DG and define RTU₍ₙ₋₁₎ to be the upstream RTU, the RTU connected to the DG upstream from the first DG. Also, define RTUₙ₊₁ to be the downstream RTU. The flow chart depicted in FIG. 8 shows the routine executed by RTUₙ. Basically, the algorithm can be explained as follows; the farthest DG RTU's assumes that the maximum voltage of the feeder equals to its own DG voltage. Also, it checks for any minimum voltage point between itself and the upstream DG, then it estimates this minimum point and send it to the upstream DG accompanied with a flag indicating the possibility of the existence of a minimum voltage point. Upon receiving these data from the downstream RTU, the upstream RTU will check if its voltage is greater than the downstream voltage and update the maximum voltage of the feeder accordingly. Also, if the minimum voltage flag is high, then the upstream RTU will check the condition for the existence of a minimum voltage point from its own side and calculate an estimate for the minimum voltage value and hence, update the minimum voltage of the feeder.

In summary, along the way from the farthest RTU till the voltage regulator, each RTU updates the maximum voltage value and the minimum voltage value of the feeder according to its readings. As a result, the voltage regulator controller will receive the maximum voltage and the minimum voltage of each feeder.

After receiving the maximum and minimum voltages of each feeder, the voltage regulator will determine the absolute maximum and minimum voltage of all the feeders. Based on these values, the voltage regulator will change the tap position accordingly as follows;
1. If the absolute maximum voltage is greater than maximum permissible voltage, then the voltage regulator will decrease the current tap position till the maximum voltage of the feeder is within the permissible range.
2. If the minimum voltage of the feeder is below the minimum permissible voltage, then the voltage regulator will increase the tap position to bring the minimum voltage into the permissible range.

### V. Optimal Operation of Switched Capacitor Banks in Distribution Feeders Algorithm: Single Capacitor Case

The main goal of the algorithm executed by the RTU is to enable the capacitor to determine the optimal reactive power injection based on system conditions. The optimal reactive power is defined as the value that will:
1. Minimize the losses of the feeder.
2. Does not cause a violation of the voltage profile along the feeder.

Firstly, a measure for the losses corresponding to each reactive power injection at the capacitor bus is introduced. In present invention, the voltage at every node of the system is not measured; therefore, the exact amount of losses cannot be determined. However, knowledge of the reactive power that minimizes the losses is sufficient to complete the method. In the present system, the voltage difference between the buses are considered as a measure for the losses in the lines.

As the difference between the voltage of buses is reduced, the losses are reduced.

The following algorithm provides the reactive power injection at the capacitor that will minimize the voltage difference between the buses. In other words, the optimal reactive power injection at the capacitor is the one that will minimize the losses-index defined as:

losses_index=Σₙ₌₁^{N-1}(Vₙ−Vₙ₊₁)² [Equation 14]

where N is the total number of minimum and maximum voltage points of the voltage profile of the feeder.

Secondly, for the capacitor's RTU to determine the optimal reactive power injection that will not violate the voltage profile, it has to know the maximum and the minimum value of the voltage profile corresponding to each possible reactive power injected at the capacitor's bus.

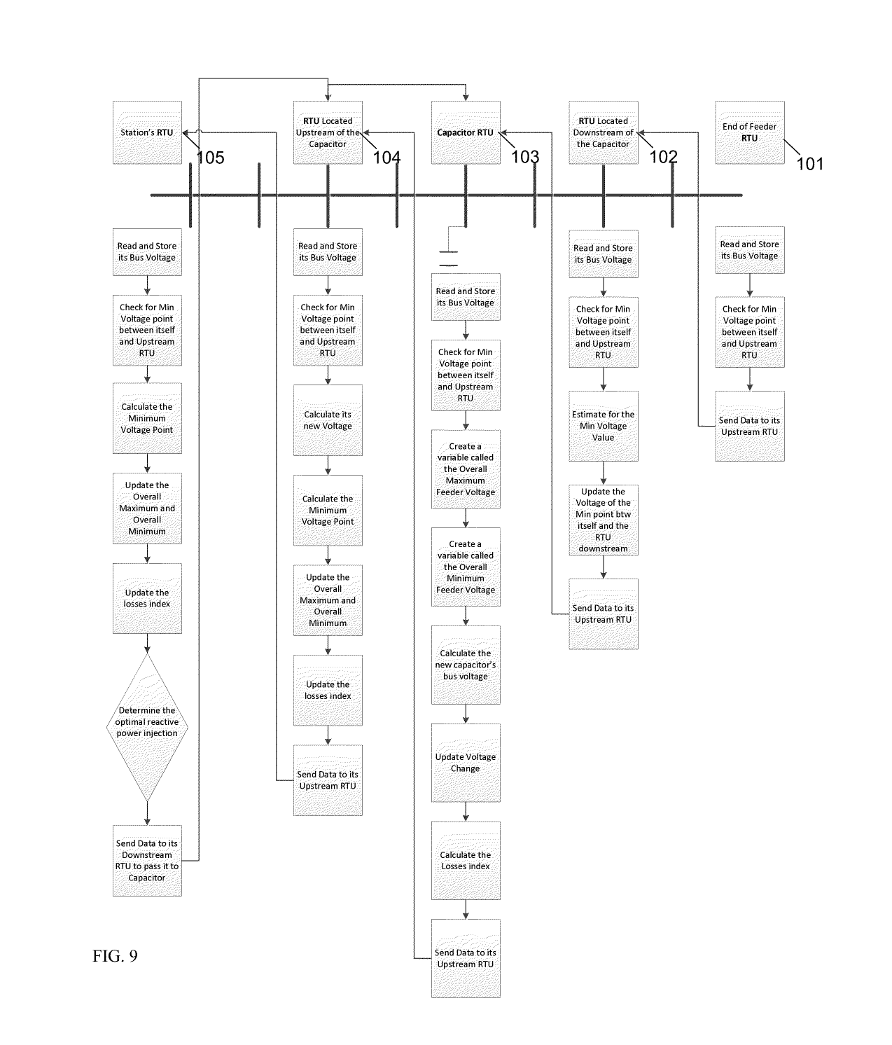

In summary, the new algorithm enables the capacitor to determine three main values corresponding to each possible reactive power injection; the maximum voltage of the feeder, the minimum voltage of the feeder and the value of the losses-index. As shown in FIG. 9 the algorithm starts off at the farthest RTU 101, from the station. There are five different types of RTU according to their locations relative to the capacitor. These types are; End of feeder RTU 101, RTU located downstream of the capacitor 102, Capacitor RTU 103, RTU located upstream of the capacitor 104, and the station's RTU 105. In the following, the algorithm executed by each RTU type is described;

End of feeder RTU 101, will:
1—read and store its bus voltage;
2—check for minimum voltage point between itself and its upstream RTU 102, then it will estimate this minimum point, if exists; and
3—send to its upstream RTU 102, its own voltage and the estimated voltage of the minimum point accompanied with a flag indicating the possibility of the existence of a minimum voltage point.

RTU downstream of the Capacitor 102, will:
1—read and store its bus voltage;
2—if the minimum voltage flag received from the downstream RTU 101, is high, check the condition for the existence of a minimum voltage point from its own side and calculate an estimate for the minimum voltage value and hence, update the voltage of the minimum point between itself and the RTU downstream 101, of it using equation (3);
3—check for minimum voltage point between itself and its upstream RTU 103, then estimate this minimum voltage point, if exists; and
4—send to its upstream RTU 103, the following: the value of its voltage, the values of the voltages received from any downstream RTU and the estimated voltage of the minimum point between itself and the upstream RTU accompanied with a flag indicating the possibility of the existence of a minimum voltage point.

Following the above procedure, the capacitor's RTU 103, will receive all the maximum and minimum points of the voltage profile of the part of the feeder downstream of the capacitor.

The Capacitor's RTU 103, will:
1—carry out the first three tasks same as the RTU downstream of the capacitor 102, as described above;
2—create a variable called the Overall Maximum Feeder Voltage corresponding to each of the possible capacitor's reactive power injection;
3—create a variable called the Overall Minimum Feeder Voltage corresponding to each of the possible capacitor's reactive power injection;
4—calculate the new capacitor's bus voltage corresponding to each possible reactive power injection utilizing equation (13);
5—voltage change for the points downstream of the capacitor is the same as voltage change of the capacitor bus. So the capacitor can update the voltages of the points downstream of its bus based on the data it has received from its downstream RTU 102;
6—having the new voltages corresponding to the possible reactive power injection for the part of the feeder downstream of the capacitor, the capacitor's RTU 103, can update the Overall Maximum and the Overall Minimum Feeder Voltage variables;
7—having the new voltages corresponding to the possible reactive power injections for the part of the feeder downstream of the capacitor, the capacitor's RTU 103, can calculate the losses-index for that part using equation (14); and
8—send to its upstream RTU 104, the following: Overall Maximum Feeder Voltage, Overall Minimum Feeder Voltage, the losses-index, list of all the possible reactive power injections at its bus, the voltage of the capacitor bus.

RTU upstream of the Capacitor 104, will:
1—carry out the first three tasks same as the RTU downstream of the capacitor 102, as described above;
2—calculate its new voltages corresponding to the possible reactive power injections at the capacitor using equation (13);
3—if there is a minimum voltage point downstream of the subject RTU 103, the subject RTU 104, will calculate the new voltages of the minimum point corresponding to the possible reactive power injection at the capacitor using equation (13);
4—update the Overall Maximum and Overall Minimum feeder voltages variables according to its calculations of the new voltages at its bus and at the minimum point downstream of it;
5—if there is a minimum point downstream of the subject RTU 104, the subject RTU 104, will calculate the losses-index between that minimum point and the downstream RTU in addition to the losses-index between itself and that minimum point. Otherwise, it will calculate the losses-index between itself and the downstream RTU 103. In any case, it will update the losses-index received from the downstream RTU 103, accordingly; and
6—send to its upstream RTU 105, the following: Overall Maximum Feeder Voltage, Overall Minimum Feeder Voltage, the losses-index, list of all the possible reactive power injections at its bus, the voltage of its own bus.

The station RTU 105, will:
1—carry out the first three tasks same as the RTU downstream of the capacitor 102, as described above;
2—if there is a minimum voltage point downstream of the subject RTU 104, the subject RTU 105, will calculate the new voltages of the minimum point corresponding to the possible reactive power injection at the capacitor using equation (13);
3—update the Overall Maximum and Overall Minimum feeder voltages variables according to its calculations of the new voltages at its bus and at the minimum point downstream of it;
4—if there is a minimum point downstream of the subject RTU 104, the subject RTU 105, will calculate the losses-index between that minimum point and the downstream RTU in addition to the losses-index between itself and that minimum point. Otherwise, it will calculate the losses-index between itself and the downstream RTU. In any case, it will update the losses-index received from the downstream RTU accordingly;
5—at this point the station RTU 105, will have the Overall Maximum Feeder Voltage, Overall Minimum Feeder Voltage, the losses-index for the whole feeder. So the station's RTU 105, will determine the optimal reactive power injection which corresponds to the minimum losses and, at the same time, does not violate the voltage profile; and
6—send to the downstream RTU 104, the optimal reactive power injection to pass it to the capacitor.

In another embodiment of the present system, a counter is placed at the capacitor RTU 103, to count how many switching operations takes place in a certain predetermined period. If the number of allowable switching operations is reached the capacitor will convert to the idle status. This limits the number of switching operations of capacitors to meet the practical operation practice.

In another embodiment of the present system, a capacitor-flag that indicates that the capacitor is downstream is added to the system. The only RTU that is allowed to set this flag high is the capacitor's RTU. As messages propagate from the end of feeder, each RTU will decide its location as follows: As long as the capacitor flag is low, then the location is downstream of the capacitor. This system makes it possible dynamically define RTU location as upstream or downstream of the capacitor.

### Optimal Operation of Switched Capacitor Banks in Distribution Feeders Algorithm: General Case

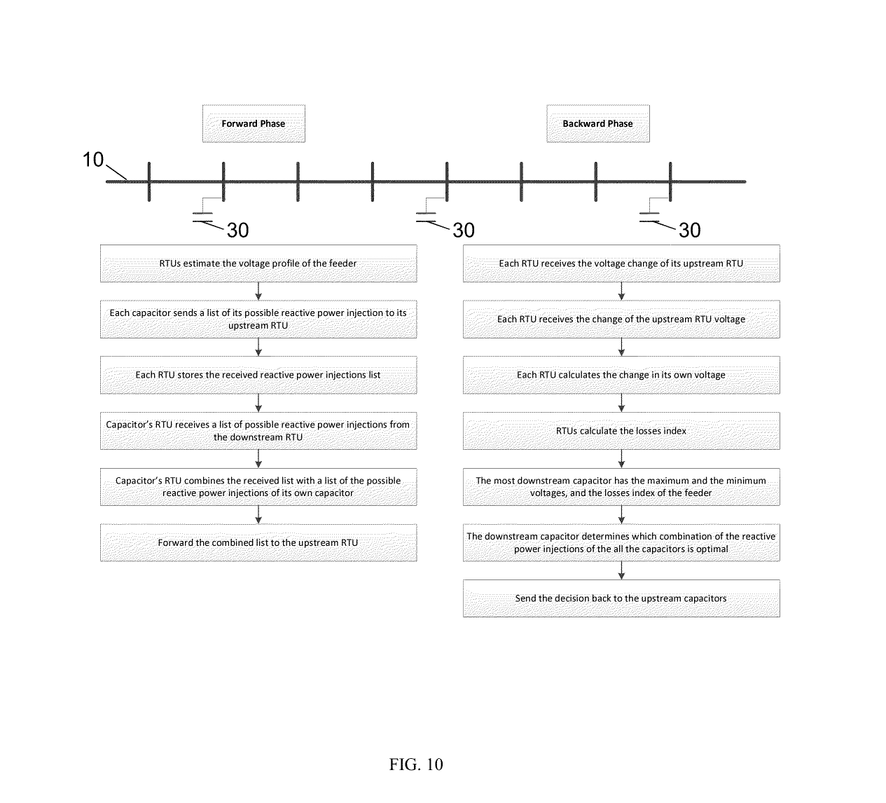

As shown in FIG. 10, a new and generalized algorithm is presented to tackle the case where more than one capacitor 30, exists on the feeder 10. One can notice that equation (7) is a general equation that gives the voltage change at a certain bus in terms of the voltage change at its upstream bus. This equation can be used to estimate the voltage change at a certain bus given the reactive power flow between this bus and its upstream bus.

In order to calculate the voltage change due to the reactive power injections at a certain RTU using equation (7), it is necessary to know the voltage change at the RTU upstream of the subject RTU. Therefore, this proposed algorithm is carried out in two phases; forward phase and backward phase. These two phases are described below;

### Forward Phase:

This phase can be described in the following steps:
1—RTUs will estimate the voltage profile of the feeder in the same manner as was discussed. More details about the voltage profile estimation algorithm can be found in FIG. 8.
2—In addition, each capacitor will send a list of its possible reactive power injection to its upstream RTU.
3—Each RTU will store the received reactive power injections list to be used in the backward phase.
4—When a capacitor's RTU receives a list of possible reactive power injections from the downstream RTU, it will combine the received list with a list of the possible reactive power injections of its own capacitor and forward the combined list to the upstream RTU.

Effectively, at the end of the forward phase each RTU will have stored its voltage and a list of the combined reactive power injections from capacitors downstream of it. Hence, for each RTU to calculate the change in its voltage due to the reactive power injections using equation (7), it only needs to have the change in the upstream RTU voltage. The forward phase will end at the station.

### Backward Phase:

The backward phase starts at the station and propagates in the downstream direction. This phase can be described as follows;
1—Each RTU will receive the voltage change of its upstream RTU. Note that, as the station bus is assumed to be stiff, the change in its voltage is zero.
2—After receiving the change of the upstream RTU voltage, each RTU will be able to calculate the change in its own voltage corresponding to the list of the reactive power injection stored at the forward phase using equation (7).
3—The RTUs will be able to calculate the losses-index in the same way described.
4—Ultimately, the most downstream capacitor will have the maximum and the minimum voltages, in addition to, the losses index of the feeder corresponding to each possible combination of the reactive power injections from feeder's capacitors.
5—Therefore, the downstream capacitor will be able to determine which combination of the reactive power injections of the all the capacitors is optimal and hence it will send its decision back to the upstream capacitors.

### VI. Simulation Results

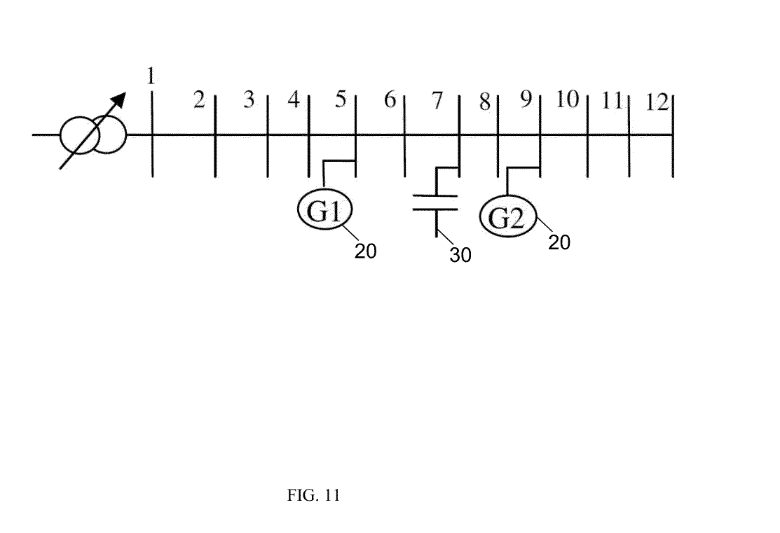

In this section several simulation results are reported to show effectiveness of the new reactive power control method. FIG. 11 shows the system under study; two DGs 20, are connected to buses 5 and 9 and a capacitor 30 is connected to bus 7. Loads connected at each bus are given in Table 1. For all of the following cases we assume the following data: The station bus voltage=1.05 pu, the maximum allowable voltage=1.06 pu, the minimum allowable voltage=0.94 pu, and the impedance of any line section=0.5+j0.46.

TABLE 1

| Bus # | P(kW) | Q(kVAR) |
|---|---|---|
| 2 | 26 | 60 |
| 3 | 40 | 30 |
| 4 | 55 | 55 |
| 5 | −80 | 0 |
| 6 | 60 | 15 |
| 7 | 55 | 0 |
| 8 | 45 | 45 |
| 9 | −250 | 0 |
| 10 | 35 | 30 |
| 11 | 40 | 30 |
| 12 | 30 | 15 |

### A. Voltage Profile Change Due to Reactive Power Injection:

In this case, we want to test the ability of the algorithm to estimate the change in the voltage profile due to the injection of reactive power at the capacitor bus. Different reactive power values are injected at the capacitor bus and the voltage profile estimated by the proposed algorithm is compared with the voltage profile obtained from a standard power flow algorithm. The proposed algorithm was able to estimate the voltage profile of the feeder efficiently given that the proposed algorithm requires much less data and acts in a decentralized manner.

### B. Optimal Reactive Power Control:

In this section, we will test the new reactive power control algorithm.

Case 1:

For the same system used above, the goal is to determine the optimal reactive power which will minimize the losses while maintain the voltage profile of the feeder. After running the algorithm the capacitor's RTU will get the data as provided in Table 2 for each possible reactive power injection.

TABLE 2

| | Q = 0 | Q = 20 | Q = 40 | Q = 65 |
|---|---|---|---|---|
| Feeder Max Voltage | 1.05 | 1.05 | 1.05 | 1.05 |
| Feeder Min Voltage | 1.0094 | 1.0130 | 1.0165 | 1.0210 |
| Losses index | 0.8136 | 0.6847 | 0.5698 | 0.4460 |

It is apparent that the optimal setting is Q=65 kVAR. To validate this results a power flow algorithm was used to calculate the losses corresponding to each reactive power injection, the results are tabulated in Table 3.

TABLE 3

| | Q = 0 | Q = 20 | Q = 40 | Q = 65 |
|---|---|---|---|---|
| Losses (kW) | 10.1 | 8.7 | 7.4 | 6.1 |

### Case 2:

In this case we will test the performance of the proposed technique in reaction to a change in DG output power. For the sake of simulation, assume that DG1 injects 200 kW and DG2 injects 300 kW. Based on the new power injections and after running the proposed algorithms, the capacitor RTU will get the data as provided in Table 4 for each possible reactive power injection.

TABLE 4

| | Q = 0 | Q = 20 | Q = 40 | Q = 65 |
|---|---|---|---|---|
| Feeder Max Voltage (p.u) | 1.05 | 1.0523 | 1.0559 | 1.0603 |
| Feeder Min Voltage (p.u) | 1.0413 | 1.0417 | 1.0452 | 1.0425 |
| Losses index | 0.370 | 0.356 | 0.0353 | 0.0350 |

Although, Q=65 causes less losses, the corresponding voltage profile will not be acceptable, as it violate the 1.06 p.u. voltage rise limit. It is apparent that the optimal setting is Q=40 kVAR. To validate this results a power flow algorithm was used to calculate the losses corresponding to each reactive power injection, the results are tabulated in table 5.

TABLE 5

| | Q = 0 | Q = 20 | Q = 40 | Q = 65 |
|---|---|---|---|---|
| Losses (kW) | 14.3 | 12.9 | 11.7 | 10.4 |

### Case 3:

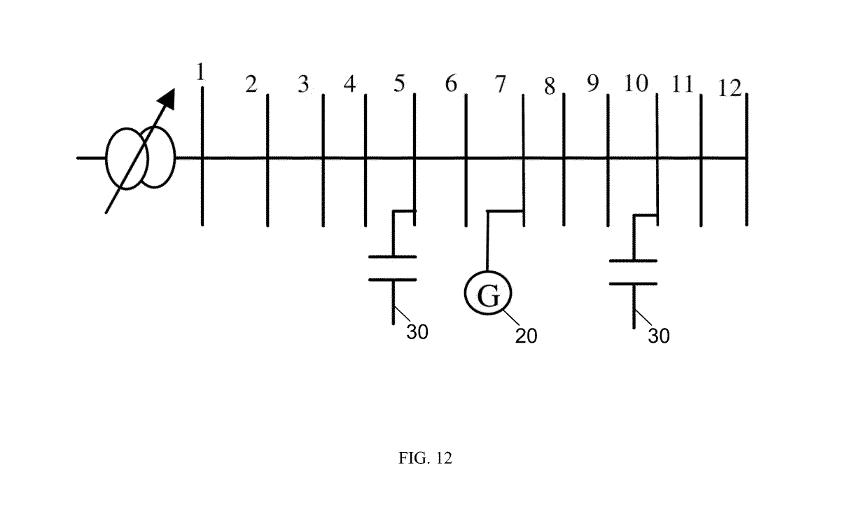

FIG. 12 shows the system under study of case 3. Loads and generation values are given in Table 6. For all of the following cases we assume the following data: The station bus voltage=1.055 pu, the maximum allowable voltage=1.06 pu, the minimum allowable voltage=0.94 pu, and the impedance of any line section=0.5+j0.46.

TABLE 6

| Bus # | P(kW) | Q(kVAR) |
|---|---|---|
| 2 | 26 | 60 |
| 3 | 40 | 30 |
| 4 | 55 | 55 |
| 5 | 20 | 0 |
| 6 | 60 | 15 |
| 7 | −400 | 0 |
| 8 | 45 | 45 |
| 9 | 35 | 0 |
| 10 | 35 | 0 |
| 11 | 40 | 30 |
| 12 | 30 | 15 |

After running the algorithm described in section V, regulator's RTU will get the data in Table 7 corresponding to each possible reactive power injection.

Based on these data, the optimal reactive power is Q1=0 and Q2=40. It should be noted that, based on the actual losses obtained from a standard power flow program, the losses corresponding to the case of Q1=35 kVAR and Q2=40 kVAR is the global minimum case. The algorithm could not get this point as it had to estimate the minimum voltage points of the voltage profile, thus, the calculation of the losses index is approximate. Even though the error is not significant, it is possible by efficient incorporation of network specific data to get a better estimation for the minimum point by assuming a more realistic load distribution between RTUs.

TABLE 7

| Possible | Maximum | Minimum | | Actual losses |
|---|---|---|---|---|
| reactive | voltage | voltage | Estimated | using a power |
| power | of the | of the | Losses | flow program |
| injection | feeder | feeder | index | (kW) |
| Q1 = 0, Q2 = 0 | 1.0550 | 1.0275 | 0.6823 | 11.6 |
| Q1 = 0, Q2 = 40 | 1.0592 | 1.0381 | 0.5843 | 9.1 |
| Q1 = 0, Q2 = 30 | 1.0574 | 1.0355 | 0.6030 | 9.7 |
| Q1 = 20, Q2 = 0 | 1.0550 | 1.0299 | 0.6764 | 10.7 |
| Q1 = 20, Q2 = 40 | 1.0616 | 1.0405 | 0.5916 | 8.5 |
| Q1 = 20, Q2 = 30 | 1.0598 | 1.0379 | 0.6068 | 8.9 |
| Q1 = 35, Q2 = 0 | 1.0562 | 1.0316 | 0.6760 | 10.1 |
| Q1 = 35, Q2 = 40 | 1.0633 | 1.0423 | 0.6017 | 8 |
| Q1 = 35, Q2 = 30 | 1.0592 | 1.0381 | 0.6142 | 8.4 |

A decentralized Volt/VAR control system is invented to efficiently control the switched capacitors of the distribution feeder in order to minimize system losses while maintaining feeder's voltage profile. The present invention is based on the coordination of several RTU located at DG buses and capacitor buses. These RTU form a multi-Agent system. Novel decentralized algorithm for the estimation of the change of the voltage profile due to the injection of reactive power at the capacitor bus was presented. Simulation results showed the effectiveness of the present invention in optimally managing the reactive power resources of the system. The present invention will help in the realization of Advanced Distribution Automation by optimally control the switched capacitors of the system to maintain acceptable voltage profile, minimize the system losses and integrate more DGs in distribution systems by effective coordination between DGs and capacitors.

What is claimed is:

1- A method to coordinate voltage control to achieve efficient voltage regulation for multiple feeders having multiplicity of buses, and distribution generations and capacitors being connected to said buses, the method comprising:
a. placing at least one RTU at each distribution generation and each capacitor, wherein each said RTU having a downstream RTU and an upstream RTU, and placing at least one RTU at each station and substation having only a downstream RTU and placing at least one RTU at the end of the feeder having only an upstream RTU, wherein said RTUs measuring voltages at each said distribution generations and each said capacitors and each said RTU communicating with its downstream and/or upstream RTUs;
b. means to determine the maximum voltage of the feeder using said measured voltages;
c. means to determine the minimum voltage of the feeder using said measured voltages;
d. means to determine changes in a voltage profile through the feeder;
e. means to determine the losses index of the feeder using said maximum and minimum voltages;
f. means to determine the optimal reactive power injection using said losses index and said voltage profile; and
g. each capacitor injecting said optimal reactive power injection into the feeder;

2- A method of claim 1, wherein said means to determine the maximum voltage of the feeder comprising:
a. recording voltages at said distribution generations and said capacitors using said RTUs;
b. means to compare said recorded voltages to determine the maximum voltage,
whereby, said maximum voltage can occur only at the distribution generators connecting buses, the capacitors connecting buses and the substation bus, provided that the resistance to impedance ratio of the feeder is constant along the whole feeder.

3- A method of claim 2, wherein said means to compare said recorded voltages to determine the maximum voltage comprising of comparing each recorded voltage at each RTU with its downstream and upstream RTU recorded voltage to determine the larger value.

4- A method of claim 1, wherein said means to determine the minimum voltage of the feeder at the end of the feeder comprising:
a. a readings of voltages at each RTU located at said buses having the distribution generator, the capacitor, and the ends of the feeders.
b. determining the minimum voltage between a RTU and its downstream RTU or its upstream RTU;
c. comparing said minimum voltages with each others; and
d. finding the lowest value of voltages of the distribution feeder.
whereby said minimum voltage can happen only at the end of the feeder or between any two distribution generators or between any two capacitor buses or between any capacitor bus and distribution generation bus.

5- A method of claim 1, wherein said means to determine the minimum voltage between distribution generators of the feeder comprising:
a. determining an average voltage by adding said readings of voltages at each RTU located at the distribution generator buses to find a sum, and dividing said sum by two;
b. determining a mean load power by finding a power difference between the active power of each said distribution generation and its upstream or downstream active power and multiplying said power difference by a quarter of resistance between them;
c. determining a mean reactive power by finding a reactive power difference between the reactive power of each said distribution generation and its upstream or downstream reactive power and multiplying said reactive power difference by half of reactance between them; and
d. determining the minimum voltage by subtracting said mean load power and mean reactive power from said average voltage.

6- A method of claim 1, wherein said means to determine the losses index of the feeder comprising:
a. determining a voltage-difference being the difference between two neighboring RTU voltages;
b. determining the square of said voltage-difference; and
c. determining said losses index by summing all said squares for total number of minimum and maximum voltage points.

7- A method of claim 1, wherein said means to determine the change in a voltage profile comprising of multiplying optimal reactive power injection by sum of reactance between each buses to find a Q-sum and adding said Q-sum to the recorded voltage at each RTU located at said distribution generation buses and each said capacitor buses prior to connection of said capacitors.

8- A method of claim 1, having means to estimate the voltage profile based on the readings of the RTUs located at the DG buses and the capacitors buses; means to estimate the change in the voltage profile due to an injection of a reactive power at a capacitor bus; and means to control a reactive power injection.

9- A method to determine the maximum voltage and the minimum voltage of a feeder, and the value of the losses-index in a system comprising multiplicity of buses, multiplicity of capacitors each having a capacitor RTU, an end of feeder RTU, a RTU located downstream of each said capacitor, a RTU located upstream of each said capacitor and a station RTU, wherein each said RTU taking local measurements at its element, perform calculations, execute a predefined logical statements and communicate with its neighbor RTU or the station, and wherein each capacitor having one or more reactive power injection values, and wherein,
a. said end of feeder RTU:
i—reads and stores its bus voltage;
ii—checks for a minimum voltage point between itself and its upstream RTU, and estimates the minimum voltage, if exists; and
iii—sends to its upstream RTU its own voltage and the estimated minimum voltage accompanied with a flag indicating the possibility of the existence of a minimum voltage point.
b. said RTU downstream of the capacitor:
i. reads and stores its bus voltage;
ii. if the minimum voltage flag received by the downstream RTU is high, checks the condition for the existence of a minimum voltage point from its own side and calculates an estimate for the minimum voltage value and updates the voltage of the minimum point between itself and the RTU downstream of it using a first equation:
$${V}_{min} = \frac{{V}_{min , DG 1} + {V}_{min , DG 2}}{2}$$
wherein V_{min,DG1} represents the minimum voltage of a downstream distribution generation and V_{min,DG2} represents the minimum voltage of an upstream distribution generation.
iii. checks for minimum voltage point between itself and its upstream RTU and then estimates this minimum voltage point, if exists; and
iv. sends to its upstream RTU the following: the value of its voltage, the values of the voltages received from any downstream RTU and the estimated voltage of the minimum point between itself and the upstream RTU accompanied with a flag indicating the possibility of the existence of a minimum voltage point, whereby following the steps b(i), b(ii) and b(iii), the capacitor's RTU receives all the maximum and minimum points of the voltage profile of the part of the feeder downstream of the capacitor,
c. said capacitor's RTU:
i. carries out the first three tasks the same as the RTU downstream of the capacitor as described in b(i), b(ii) and b(iii);
ii. creates an Overall Maximum Feeder Voltage corresponding to each of the possible capacitor's reactive power injection;
iii. creates an Overall Minimum Feeder Voltage corresponding to each of the possible capacitor's reactive power injection;
iv. calculates the new capacitor's bus voltage corresponding to each possible reactive power injection utilizing a second equation:
$${V}_{( n ) new} = {V}_{( n ) old} + {Q}_{C} {\sum }_{k = 1}^{k = n} {X}_{k - 1 , k}$$
wherein V_{(n)new} represents the voltage of bus n after connecting the capacitor, V_{(n)old} represents the voltage of bus n prior to the connection of the capacitor, Q_{C} represents the reactive power of the capacitor and X_{n-1,n} represents the reactance of the line segment between bus n−1 and bus n.
v. the capacitor updates the voltages of the points downstream of its bus based on the data it has received from its downstream RTU;
vi. having the new voltages corresponding to the possible reactive power injection for the part of the feeder downstream of the capacitor, the capacitor's RTU can update the Overall Maximum and the Overall Minimum Feeder Voltages;
vii. having the new voltages corresponding to the possible reactive power injections for the part of the feeder downstream of the capacitor, the capacitor's RTU can calculate the losses-index for that part using a third equation:
losses_index=Σₙ₌₁^{N-1}(Vₙ−Vₙ₊₁)²
wherein N is the total number of minimum and maximum voltage points of the voltage profile of the feeder; and
viii. sends to its upstream RTU the following: Overall Maximum Feeder Voltage, Overall Minimum Feeder Voltage, the losses-index, list of all the possible reactive power injections at its bus, the voltage of the capacitor bus;
d. said RTU upstream of the capacitor:
i. carries out the first three tasks same as the RTU downstream of the capacitor as described in b(i), b(ii), and b(iii);
ii. calculates its new voltages corresponding to the possible reactive power injections at the capacitor using the second equation;
iii. if there is a minimum voltage point downstream of the subject RTU, the subject RTU calculates the new voltages of the minimum point corresponding to the possible reactive power injection at the capacitor using the second equation;
iv. updates the Overall Maximum and Overall Minimum feeder voltages variables according to its calculations of the new voltages at its bus and at the minimum point downstream of it;
v. if there is a minimum point downstream of the subject RTU, the subject RTU calculates the losses-index between that minimum point and the downstream RTU in addition to the losses-index between itself and that minimum point, otherwise, it calculates the losses-index between itself and the downstream RTU, and in any case, it updates the losses-index received from the downstream RTU accordingly; and
vi. sends its upstream RTU the following: Overall Maximum Feeder Voltage, Overall Minimum Feeder Voltage, the losses-index, list of all the possible reactive power injections at its bus, the voltage of its own bus;
e. said station RTU:
i. carries out the first three tasks same as the RTU downstream of the capacitor as described in steps b(i), b(ii), and b(iii);
ii. if there is a minimum voltage point downstream of the subject RTU, the subject RTU will calculate the new voltages of the minimum point corresponding to the possible reactive power injection at the capacitor using the second equation;
iii. updates the Overall Maximum and Overall Minimum feeder voltages variables according to its calculations of the new voltages at its bus and at the minimum point downstream of it;
iv. if there is a minimum point downstream of the subject RTU, the subject RTU will calculate the losses-index between that minimum point and the downstream RTU in addition to the losses-index between itself and that minimum point, otherwise, it will calculate the losses-index between itself and the downstream RTU. In any case, it will update the losses-index received from the downstream RTU accordingly;
v. at this point the station RTU will have the Overall Maximum Feeder Voltage, Overall Minimum Feeder Voltage, the losses-index for the whole feeder. So the station's RTU will determine the optimal reactive power injection which corresponds to the minimum losses and, at the same time, does not violate the voltage profile; and
vi. send to the downstream RTU the optimal reactive power injection to pass it to the capacitor.
whereby the maximum and the minimum voltages are used to obtain a voltage regulation and reactive power control for the feeder.

10- A method of claim 1, said system further having a counter placed at each said capacitor RTU to count how many switching operations takes place in a certain predetermined period, and if the number of allowable switching operations is reached the capacitor converts to an idle status, whereby the number of switching operations of capacitors to meet the practical operation practice being limited.

11- A method of claim 1, said system further having a capacitor-flag that indicates that the capacitor is downstream, wherein as messages propagate from the end of feeder, each RTU decides its location as follows: as long as the capacitor flag is low, then the location is downstream of the capacitor, whereby the system makes it possible to dynamically define RTU location as upstream or downstream of the capacitor.

12- A method of claim 1, wherein the minimum voltage between the DGs or capacitor connecting buses comprising the following steps:
a. if and only if, for both DGs, the voltage of the DG neighboring bus, in the direction of the other DG, is less than the voltage of the DG bus;
b. check whether there is a minimum point in between two elements; and
c. estimate the value of the minimum voltage point using the readings available at the DG or the capacitor bus only.

13- A method of claim 1, wherein said RTU being a microprocessor system or a controller device having inputs for measurements and executes algorithms.

14- A method to coordinate voltage control to achieve efficient voltage regulation for multiple feeders having multiplicity of buses, and distribution generations and capacitors being connected to said buses, the method comprising: multiplicity of RTUs located at each bus having a capacitor and or a distribution generation (DG), wherein each RTU measures the voltage of its element bus, active and reactive power flow in lines connected to its element bus and the voltages of the immediate neighbor buses of its element bus, whereby the voltage of the immediate neighbor buses is needed only in order for the RTU to get the trend of the voltage profile, increasing or decreasing, thus, measuring a point on the feeder adjacent to the RTU could be sufficient, and wherein based on the measurements of each RTU, it will be able to,
a. measure a maximum voltage point of the voltage profile; the DG or the capacitor bus voltage;
check one part of the condition for the possibility of the existence of a minimum voltage point of the voltage profile between its element and any neighbor element;
b. estimate the value of the minimum voltage point on each side of its element, if exists;
c. this communication structure represents a tree in which the station is the root of the tree, each feeder segment is a branch and each RTU is a node.
